(19) United States
(12) Patent Application Publication
(10) Pub. No.: US 2001/0048526 A1
(43) Pub. Date: Dec. 6, 2001

(54) Compact spectrometer

(75) Inventor: Eliyahu Bender, Jerusalem (IL)

Correspondence Address: DARBY & DARBY P.C., 805 Third Avenue, New York, NY, 10022, US

(73) Assignee: Ophir Optronics Ltd.

(21) Appl. No.: 09/850,432

(22) Filed: May 7, 2001

(30) Foreign Application Priority Data
May 7, 2000 (IL) 136,006

(51) Int. Cl. G01J 3/28

(52) U.S. Cl. 356/328

(57) ABSTRACT

A dispersive spectrometer whose dispersive element is aligned such that the direction of dispersion is essentially perpendicular to the collimating plane, which is the plane of the input beam path between the centers of the input slit, the collimating mirror and the dispersive element. As a result of this construction, the lateral spread over which the beam path traverses is reduced, since use is also made of the direction perpendicular to the input beam path plane for the dispersive spread of the beam, and the spectrometer is thus of compact construction.

### FIELD OF THE INVENTION

The present invention relates to the field of instrumentation for the measurement of the wavelength of light, especially using dispersive spectrometric methods.

### BACKGROUND OF THE INVENTION

A method commonly used for the measurement of the wavelength of light, or if polychromatic, the wavelength components of light, whether in the ultra-violet, the visible or the infra-red region of the spectrum, is by means of a spectrum analyzer based on dispersive spectrometry. The spectral components of the light are separated by means of a dispersive element, such as a prism or a grating, and the position of the individual spatially separated component or components of the light are determined by means of a spatial detector, such as a linear detector array. A CCD detector is commonly used for this purpose. It should be noted that although the subject of this specification is described as a spectrometer, the terms spectrum analyzer or wavemeter are also understood to be alternative descriptive terms for the invention, all being instruments for measuring the wavelength of light by means of dispersive spectroscopy.

Commonly used configurations in currently available industrial miniature spectrometers resemble miniature versions of the classical spectrometer designs used since the nineteenth century, except that a detector array is used instead of photographic plates. The light is input to the spectrometer by means of a slit, which provides a well-defined narrow segment of light for good spatial resolution. The light emitted from this slit is then reflected by means of a mirror onto a reflective diffraction grating, from where it is dispersed according to its wavelength composition. The differently directed beams from the diffraction grating are reflected and focused by means of another mirror onto the linear detector array. The reflective mirrors are generally concave, with focal properties such as to provide a collimated beam for input to the diffraction grating, and to focus the output beams from the diffraction grating onto the detector array plane.

In this prior art configuration, the path of the light from the slit source, via the input mirror, the grating and the output mirror to the detector is essentially planar, including the dispersed components after the grating. Since the dispersive properties of the grating are such that the incident and diffracted beams have to be angularly separated, and since the detector array itself has a comparatively long length, the dispersed beams paths become spatially spread out in this beam path plane. This configuration thus occupies a comparatively large area, especially when mirrors with a long focal length are used in order to provide good spatial resolution of the dispersed light. A prior art instrument is shown in the brochure on the S2000 range of spectrometers, published in 1999 by OceanOptics Inc. of Dunedin, Fla. This range of spectrometers use a crossed Czemy-Tumer design to reduce the area of the spectrometer, but the design remains essentially planar.

Furthermore, when the focusing optics consists only of spherical mirrors, the spherical field of the slit cannot be converted into a flat field, which is required to ensure accurate focusing along the complete length of the detector array. One common method used in prior art spectrometers for providing a flat field at the detector is by the use of a grating with special geometry or special grooves, such as a concave grating, or a grating with an even more complex profile. Such a prior art instrument, which uses an aberration-corrected concave grating is shown in the brochure on the MMS 1 Monolithic Miniature Spectrometer, published by the Carl Zeiss Company of Oberkochen, Germany. However, such a grating is a non-standard component, and is thus probably more costly than a conventional planar grating.

Additionally, the use of concave mirrors in an off-axis configuration results in a non-negligible level of astigmatism. If a concave grating is used close to its normal, this astigmatism can be virtually eliminated by illuminating the grating with collimated light, as should be obtained from a point source at the focus of the concave mirrors. This is the basis for the astigmatic-free Wadsworth spectrometric mounting, as devised at the end of the nineteenth century.

In contrast to the requirements of the large standards-type high precision spectrometers used for charting basic spectrometric data, astigmatism is not generally an important aberration in spectrometers for industrial and common laboratory use. This is because even with some residual astigmatism, the optical design should be optimized to ensure good focusing of the slit along the length (the long dimension) of each segment of the detector array, and slight defocusing in the other direction will have negligible effect on the accuracy of measurement. However, depending on the exact optical configuration, other aberrations, including spherical aberration, may also be present, with a consequent loss of accuracy and resolution. Prior art solutions for overcoming these aberrations include the use of parabolic mirrors for performing the focusing functions. Such aspheric mirrors, like the concave gratings, are also non-standard components, and more costly than conventional spherical mirrors.

One prior art method for reducing the size of spectrometers is the use of a custom designed diffraction grating, which may have a specially constructed geometric profile and/or a specially constructed groove profile. Such gratings are able to perform both the dispersive and focusing functions of the conventional spectrometers described above, thereby reducing the number of components needed and the instrument size. However, because of the complexity of such gratings, it may be difficult to achieve the desired basic functional design performance and at the same time to reduce aberrations to minimal levels. Furthermore, production control of the accuracy and reproducibility of such components may be more difficult to achieve than for well-defined flat gratings. As a result, compact spectrometers using such complex gratings often have their resolution and accuracy limited because of residual aberrations or production inaccuracies. Furthermore, such complex gratings may be expensive to produce because of the high cost of the master grating.

Prior art spectrometers thus suffer from a number of disadvantages. In the first place, the conventional designs occupy a comparatively large area, because of the planar layout of the components. In addition, they may be comparatively costly because of the need for special elements, such as concave gratings and aspheric mirrors, for correction of the aberrations inherent in their optical design. Those spectrometers which use a complex grating for both dispersive and focusing functions, may be more compact than conventional designs, but may suffer from reduced resolution or accuracy. There therefore exists a need for a compact, less costly spectrometer, while maintaining high levels of accuracy and resolution, in order to fulfill the needs of industrial and common laboratory optical wavelength measurements.

The disclosures of each of the publications mentioned in this section and in other sections of this specification, are hereby incorporated by reference, each in its entirety.

### SUMMARY OF THE INVENTION

The present invention seeks to provide a new dispersive spectrometer, which is compact, simple in construction, uses few components, and overcomes common aberrations, so as to provide accurate measurements of high resolution. The spectrometer of the present invention achieves these objectives primarily by departing from the conventional planar beam path and component layout geometry hitherto used in prior art spectrometers.

There is thus provided in accordance with a preferred embodiment of the present invention, a dispersive spectrometer wherein the dispersive element is aligned such that the direction of dispersion is essentially perpendicular to the collimating plane, which is defined by the plane of the input beam path between the centers of the input slit, the collimating mirror and the dispersive element. The terms input and output are generally used and claimed throughout this specification to describe the beam or beam path respectively before and after diffraction by the dispersive element. The plane of the beam before dispersion is thus termed the input collimating plane, or similar, and the plane of the fan of beams diffracted from the dispersive element is termed the plane of dispersion, or the output plane, or similar.

As a result of this novel construction, the lateral spread over which the beam path traverses is reduced, since use is also made of the direction perpendicular to the input beam path plane for the dispersive spread of the beam. The reflective elements in the input and output legs of the dispersive element can thus be moved close to each other, since there is now planar discrimination of the light traversing the spectrometer between the input collimating plane and the dispersion plane. Because of this angular discrimination, it even becomes possible to use a single concave mirror to reflect both the input beam of light to the dispersive element, and the output beam of light from the dispersive element. These features thus enable the spectrometer of the present invention to be constructed more compactly and more simply than conventional layout prior art spectrometers, and using fewer optical components. The spectrometer may consequently also be of lower cost than prior art spectrometers.

According to a further preferred embodiment of the present invention, a correction lens assembly is used in the common input and output optical paths to and from the dispersive element, in order to correct for aberrations arising in the optical system, and in particular, to provide a flat field at the detector array. This enables the use both of a standard flat diffraction grating as the dispersive element, and of a standard spherical mirror to fulfill the collimating/focusing functions. A further advantage of such a correction lens assembly is that it enables the path length of the light to be shortened, so that the spectrometer becomes physically shorter, yet without altering the effective focal length of the mirrors, and hence the resolving power.

Although the invention and its preferred embodiments are described in this specification in terms of the commonly used reflective spectrometer, it is to be understood that the invention can equally be used for spectrometers which use lenses for collimating, focusing and directing the light along the desired path within the spectrometer.

In accordance with yet another preferred embodiment of the present invention, there is provided a spectrometer consisting of an input collimating plane and a dispersion plane aligned at a substantially different angle from each other. In the spectrometer described above, the input collimating plane and the dispersion plane may be essentially perpendicular.

In accordance with still another preferred embodiment of the present invention, there is provided a spectrometer consisting of an input slit, a dispersive element and a detector element, wherein the dispersive element is aligned such that a beam of light from the input slit dispersed by the element and impinging on the detector element follows an essentially non-planar path. The dispersive element may preferably be a diffraction grating, which could be planar.

In accordance with a further preferred embodiment of the present invention, there is also provided a spectrometer as described above, and also consisting of at least one mirror for performing input collimation and output focusing. The at least one mirror could be either concave or spherical, and could be only a single mirror.

There is even further provided in accordance with another preferred embodiment of the present invention, a spectrometer as described above, and also consisting of a correction lens assembly which is operative to reduce optical aberrations. The lens may also preferably be operative to reduce the optical path length of the spectrometer. Furthermore, in accordance with yet another preferred embodiment of the present invention, the correction lens assembly may be disposed such that the beam passes through the lens assembly on each of its traverses through the spectrometer. These traverses could consist of passage of the beam from the input slit to the mirror, from the mirror to the dispersive element, from the dispersive element to the mirror and from the mirror to the detector element.

There is also provided in accordance with a further preferred embodiment of the present invention, a spectrometer as described above, and wherein each of the beam traverses takes place approximately paraxially.

In accordance with yet another preferred embodiment of the present invention, there is provided a spectrometer as described above, and wherein the lens assembly is optimized to reduce aberrations by performing ray tracing with the rays passing through the lens assembly on each traverse through the spectrometer.

There is further provided in accordance with yet another preferred embodiment of the present invention, a method of reducing the size of a spectrometer having a dispersive element and an input collimating plane, by aligning the dispersive element such that light is dispersed in a plane at an angle significantly different to the input collimation plane. In the method described above, a single element may preferably be used for reflecting the beam to and from the dispersive element.

There is further provided in accordance with still another preferred embodiment of the present invention, a method of reducing aberrations in a spectrometer having a dispersive element, an input collimating plane, at least one beam reflector and at least one correcting lens, consisting of the steps of aligning the dispersive element such that light is dispersed in a plane at an angle significantly different to the input collimation plane, reflecting the dispersed light off the at least one beam reflector such that the beams before and after reflection are closely disposed, inserting the at least one correcting lens in the path of the beams, and optimizing at least one of the at least one correcting lens and its position, in order to minimize the aberrations.

### BRIEF DESCRIPTION OF THE DRAWINGS

The present invention will be understood and appreciated more fully from the following detailed description, taken in conjunction with the drawings in which:

FIG. 1 is a schematic view of a prior art spectrometer, wherein the input collimation and output dispersion planes are coplanar;

FIG. 2 is a schematic isometric view of the prior art spectrometer shown in FIG. 1;

FIG. 3 is a schematic view of a spectrometer according to a preferred embodiment of the present invention, wherein the dispersion plane of the spectrometer shown in FIG. 1, is rotated to be perpendicular to the plane of input collimation;

FIG. 4 is a schematic isometric view of the spectrometer according to a preferred embodiment of the present invention shown in FIG. 3;

FIG. 5 is a schematic view of a spectrometer according to another preferred embodiment of the present invention, wherein the two mirrors shown in FIGS. 3 and 4 are combined into one element;

FIG. 6 is a schematic view of a spectrometer according to a further preferred embodiment of the present invention, including a lens in the optical paths for correction of aberrations present in the embodiment shown in FIG. 5;

FIG. 7 is the result of an optimization routine performed on the optical design of the spectrometer shown in FIG. 6;

FIG. 8 is a plot of the spot diagram obtained from the optimization whose results are shown in FIG.7; and

FIG. 9 is a graph showing the accuracy achieved using the spectrometer of FIG. 6 to measure spectral lines from a mercury-argon discharge lamp.

### DETAILED DESCRIPTION OF PREFERRED EMBODIMENTS

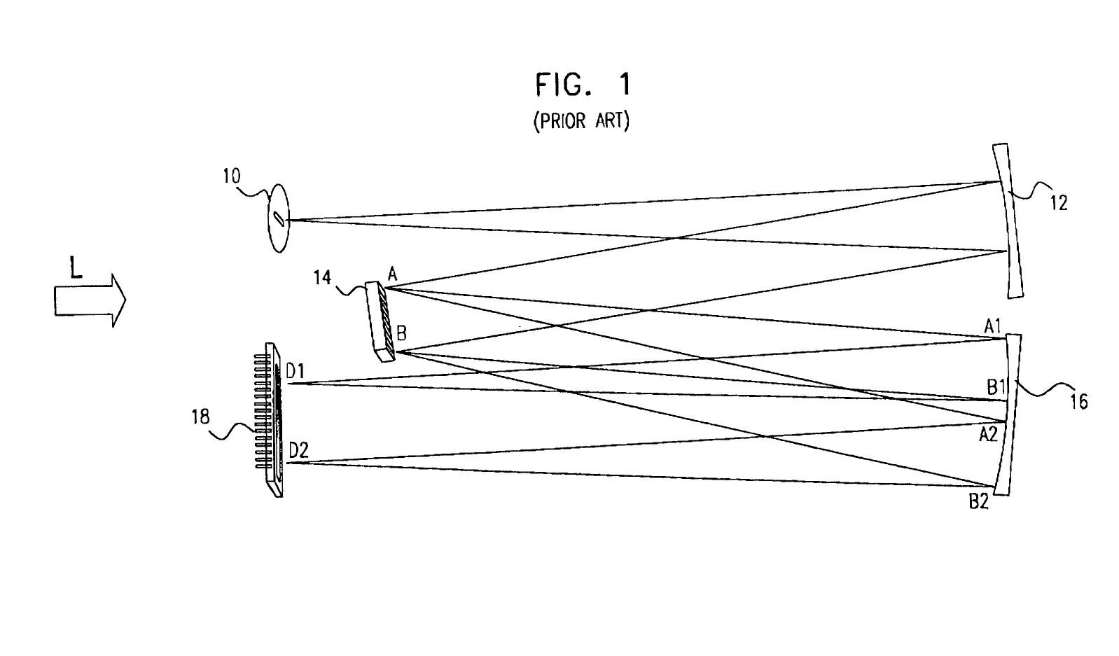

Reference is now made to FIG. 1, which illustrates schematically a plan view of a spectrometer according to a commonly used prior art configuration, with the input collimation plane, the dispersion plane and the output focusing plane, together with their corresponding components, sharing a common plane, located in the plane of the paper. The light whose spectrum is to be analyzed is allowed to fall on an input slit 10, whose long dimension lies perpendicular to the aforementioned common plane. The input light may optionally be collected and focused onto the input slit by means of an objective lens, as is well known in the art. The slit is located at the focal point of a concave mirror 12. The light emerging from the slit diverges according to the angle dictated by the input optics (not shown), and at the input mirror location, is generally arranged to fill a large part of the mirror aperture. Any diffraction resulting from the narrowness of the slit is added to the divergence dictated by the input optics.

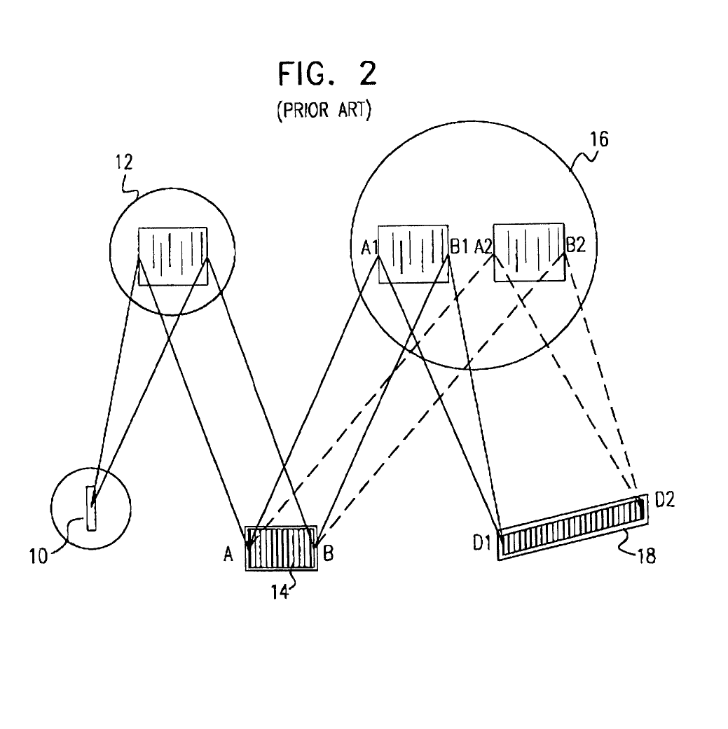

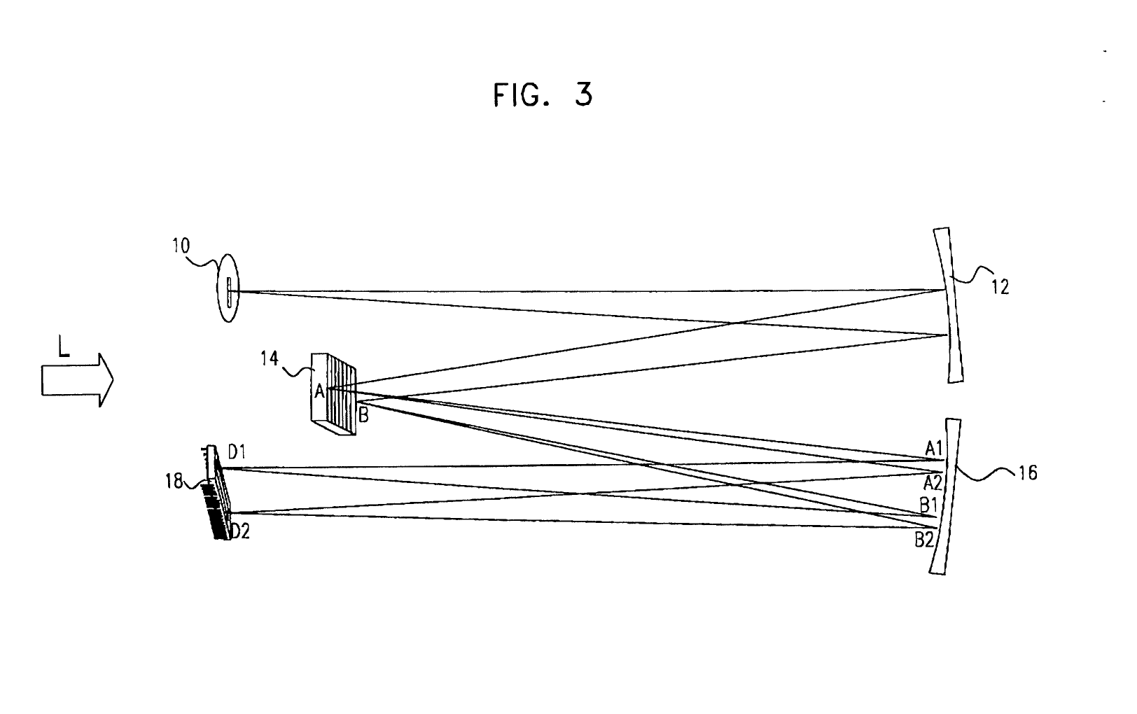

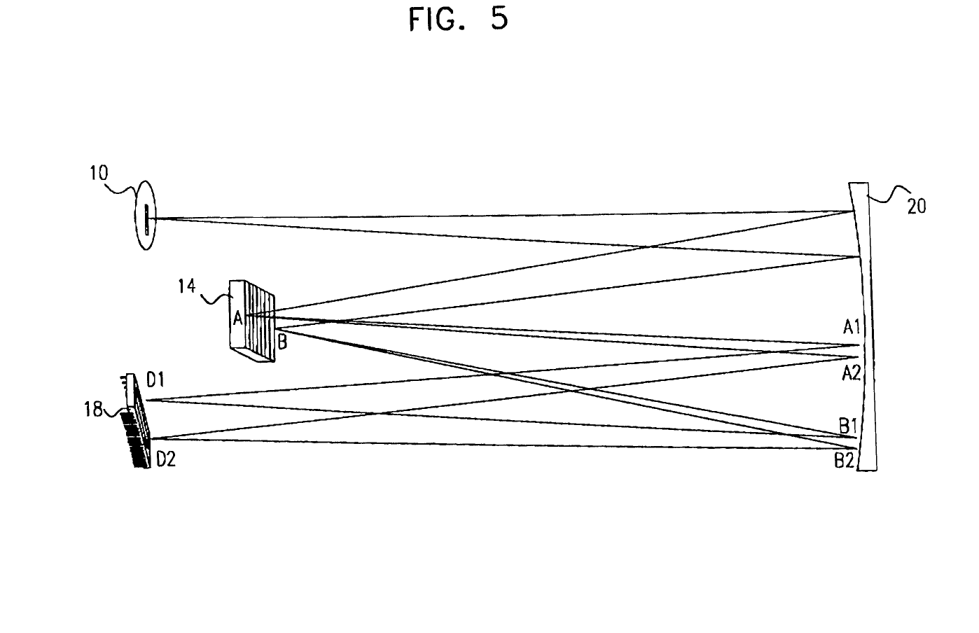

In FIG. 1, and in the subsequent FIGS. 3 and 5, only the rays from a single point at the center of the slit are shown, in order to avoid complicating the drawings. In FIG. 1, for instance, it should be understood that the whole length of the slit emits light, and that the illumination beam from the slit extends, at approximately the same length of the slit, in the plane perpendicular to the paper. In order to illustrate the second dimension of the light beams, omitted for clarity from the scale drawing in FIG. 1, an isometric schematic view of this prior art spectrometer, as seen from the direction L along the length of the spectrometer, is shown in FIG. 2. The signs attached to the components in FIGS. 1 and FIG. 2 are identical.

The concave mirror 12 is disposed slightly tilted to the input beam of light, such that the light is reflected from the concave mirror towards the diffraction grating 14 and with the input plane essentially perpendicular to the input slit length. Since the slit source 10 is located at the focus of the concave mirror 12, the light reflected from the concave mirror is essentially collimated. The component dimensions and locations are such that the collimated beam fills the length A-B of the diffraction grating 14. The light is dispersed by the diffraction grating according to its wavelength. The diffraction grating is aligned such that the desired order of diffracted light to be used for the measurement is directed towards the concave output focusing mirror 16. Thus, for instance, the light of wavelength λ1 is diffracted to impinge on the output focusing mirror 16 at A1-B1, while light of wavelength λ2 is diffracted to impinge on the mirror 16 at A2-B2. Although the regions A1-B1 and A2-B2 are shown for clarity completely separated in FIGS. 1 and 2, it is to be understood that that in practice, the dispersion is such that there will generally be overlap of these regions on the mirror.

The output focusing mirror 16 is also aligned with its axis tilted with respect to the collimated beams incident on it, such that these beams are focused onto the detector array 18, whose center point is located at the focal point of the concave mirror 16. The beam from the region A1-B1 of the mirror is focused onto the segment D1 of the detector, while the light from the region A2-B2 of the mirror is focused onto the segment D2 of the detector. In this way, the segments of the detector illuminated provide a measure of the wavelengths present in the incident light beam.

This prior art configuration is such that the center of the slit 10, the centers of the mirrors 12, 16, the diffraction grating 14 and the detector 18, and the dispersion direction all lie in essentially the same plane. As a result, the beam paths within the spectrometer are spread out spatially, and the instrument occupies a large surface area, as previously mentioned. In particular, the necessary length of the detector array accentuates the width of the spectrometer.

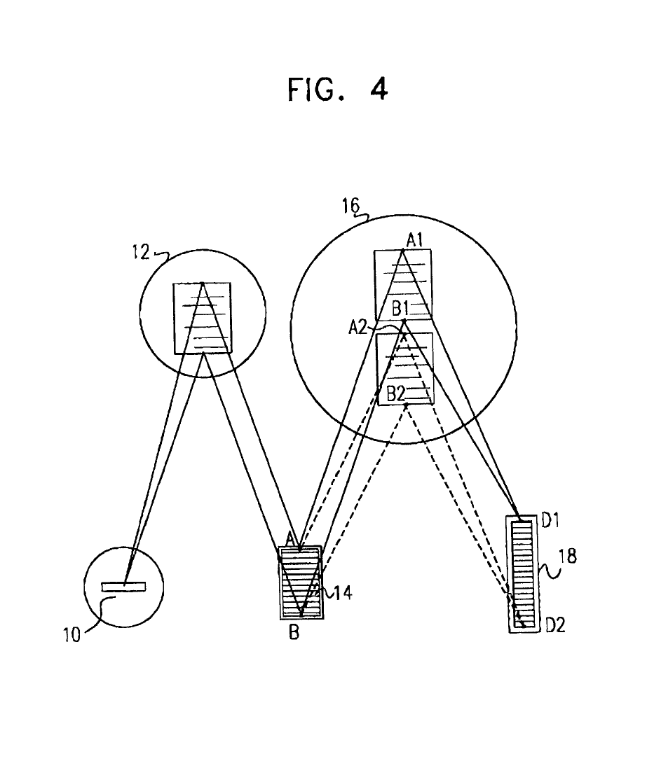

Reference is now made to FIG. 3, which illustrates schematically a plan view of a spectrometer, constructed and operative according to a preferred embodiment of the present invention. The components of the spectrometer in FIG. 3 are similar to those used in prior art spectrometers, and are labeled with the same signs as those of FIG. 1. The spectrometer shown in FIG. 3 differs, however, from the prior art spectrometer of FIG. 1, in that the plane of dispersion is rotated out of the plane of input collimation, so that the dispersion now takes place preferably in the plane normal to that of the input collimation, i.e. normal to the paper. This is achieved by rotating the dispersive element 14, by 90° about the normal to its center. In order to maintain correct relative location of the illumination on the detector array, the slit 10 and the detector array 18 also have to be rotated relative to their alignments in FIG. 1, by the same angle as the dispersive element. The relative alignments of the input collimating plane, the dispersive direction, and the output focusing plane are shown more clearly in FIG. 4, which is an isometric schematic view of the spectrometer, as seen from the direction L in FIG. 3, along the length of the spectrometer.

As a result of the essentially perpendicular mutual alignment between the input collimating plane on the one hand, and the plane of dispersion on the other hand, use is made of the third dimension in the spectrometer volume, such that the entire spectrometer according to this preferred embodiment becomes significantly more compact than the prior art spectrometer of FIG. 1. Though this preferred embodiment describes a plane of dispersion at right angles to the input collimation plane, it is to be understood that according to other preferred embodiments of the present invention, rotation by angles smaller than 90° can also be used, though the economy of space is then accordingly less. The detector array 18 can be positioned in close proximity to the dispersing element 14, and the lateral spread found in prior art spectrometers because of the length of the detector array, as is apparent in FIG. 1, is absent. In addition, the two concave mirrors 12, 16 can be moved close together, as is apparent from comparison of FIG. 4 with the prior art FIG. 2.

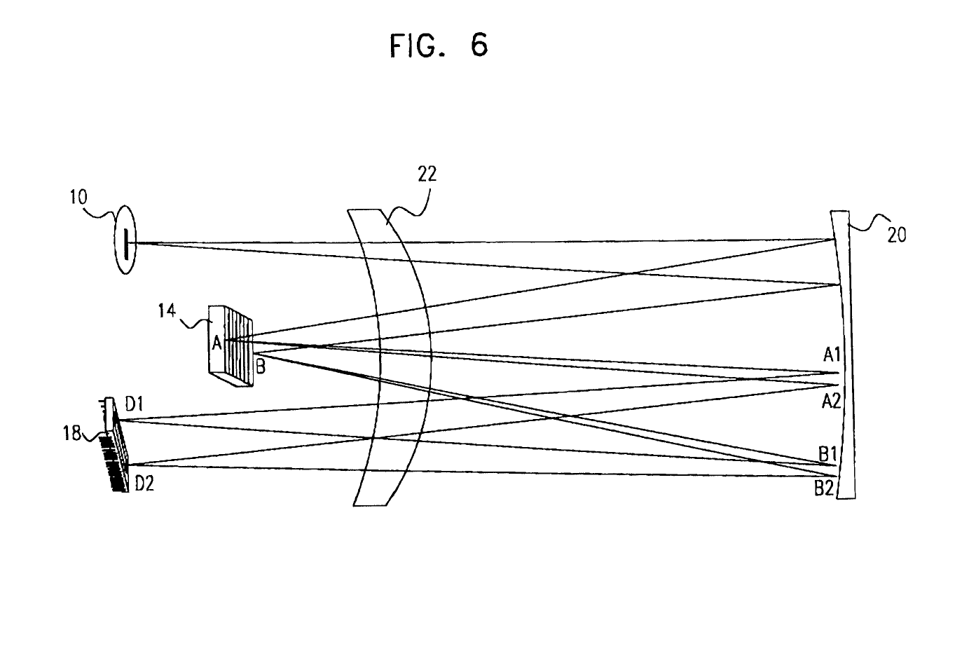

Reference is now made to FIG. 5, which shows a spectrometer according to another preferred embodiment of the present invention. In FIG. 5, the collimating and focusing functions of the two concave mirrors of the embodiment shown in FIG. 4 are combined in one concave mirror 20. The mirror may need to be somewhat larger than the individual mirrors 12, 16 shown in the embodiment of FIG. 4, but there is still a significant saving in component cost and in space by the use of a single component instead of two. The mirror shown in the embodiment of FIG. 6 is 40 mm in diameter, and it is the largest optical element in the spectrometer. Use of a comparatively small single mirror is enabled only because of the compactness of the component layout engendered by the present invention, which utilizes mutually perpendicular collimating and dispersive/focusing planes.

Reference is now made to FIG. 6, which shows the yet another preferred embodiment according to the present invention, in which, to the spectrometer of FIG. 5 is added a correction lens 22 in the common input and output optical paths, in order to correct for aberrations arising in the optical system. Because of the compact nature of the spectrometer, all four traverses of the light are able to pass through the correction lens comparatively paraxially. As a result of this, the ray tracing optical design program used to minimize the aberrations can achieve a high level of optimization, since the system can be optimized for four reasonably paraxial beam traverses simultaneously. A high degree of aberrational correction is thus achieved. The use of this correction lens reduces aberrations to such an extent that concave mirrors may be used to provide a flat field at the detector array, even with a flat grating as the dispersive element, and the resulting measurement accuracy and resolution are typical of larger and more complex instruments. With the prior art spectrometers described hereinabove, the use of a correction lens makes it difficult to achieve such a level of optimization, since even if an attempt is made to optimize the system for all four beam traverses, the geometrical spread of the beams would probably render them sufficiently non-paraxial with respect to the correction lens, to make it unlikely, under those conditions, that such an advantageous optimization could be achieved.

As an additional outcome, the use of such a correction lens enables the physical length of the spectrometer to be reduced, while still maintaining the same effective focal length mirrors, on which the spectrometer resolution depends. The use of such a lens, according to this additional preferred embodiment of the present invention, thus compounds the size advantages enabled by the use of mutually perpendicular input collimating plane and dispersion direction.

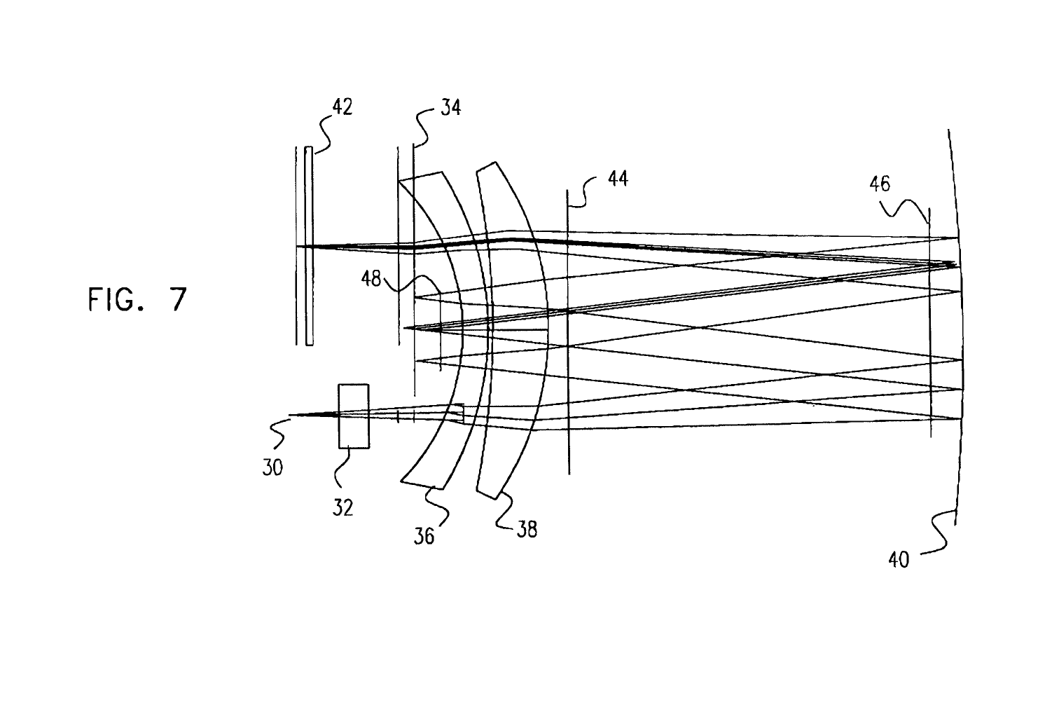

Reference is now made to FIG. 7 which shows the results of an optimization routine performed using on the complete spectrometer of FIG. 6, using the ZEMAX optical design software, supplied by Focus Software Inc. of Tucson, Ariz. In FIG. 7, the light input from the slit 30 is preferably passed through a long pass filter 32, whose function is to absorb the higher order diffraction from the grating 34, so that only the desired first order dispersion is transmitted. Alternatively, a filter allowing the use of a higher diffraction order may be used, in order to provide more dispersion and hence higher resolution, but there are also disadvantages in the use of higher orders. A lens doublet used for the aberration correction is shown at 36 and 38, and the single concave reflection mirror is shown at 40. The detector array plane is shown at 42. Baffles 44, 46 are included to reduce internal stray light from affecting the line contrast, and a stop 48 is used to provide an f/10 numerical aperture.

The optimization was performed to optimize the lens assembly to provide minimum system aberrations, as is well-known in the art. The results of an optimization run shown in FIG. 7 suggested the use of a doublet consisting of a positive and a negative meniscus lens. The lens parameters proposed are shown in Table 1, which is the relevant extract from the results of the optimization procedure shown in FIG. 7. The dimensions are in mm.

TABLE I

| Surface No. | Radius | Thickness | Glass | Diameter |
|---|---|---|---|---|
| 8 | −20.70 | 2.5 | BK7 | 30 |
| 9 | −29.63 | 0.389 | | 32 |
| 10 | −79.63 | 5.5 | BK7 | 32 |
| 11 | −29.63 | 1.976 | | 34 |

Using the above-designed lens assembly results in residual aberratios at significant sub-pixel levels. At the same time, the optical path is reduced to total of 60 mm., illustrating the size reduction achieved by use of an auxiliary lens assembly.

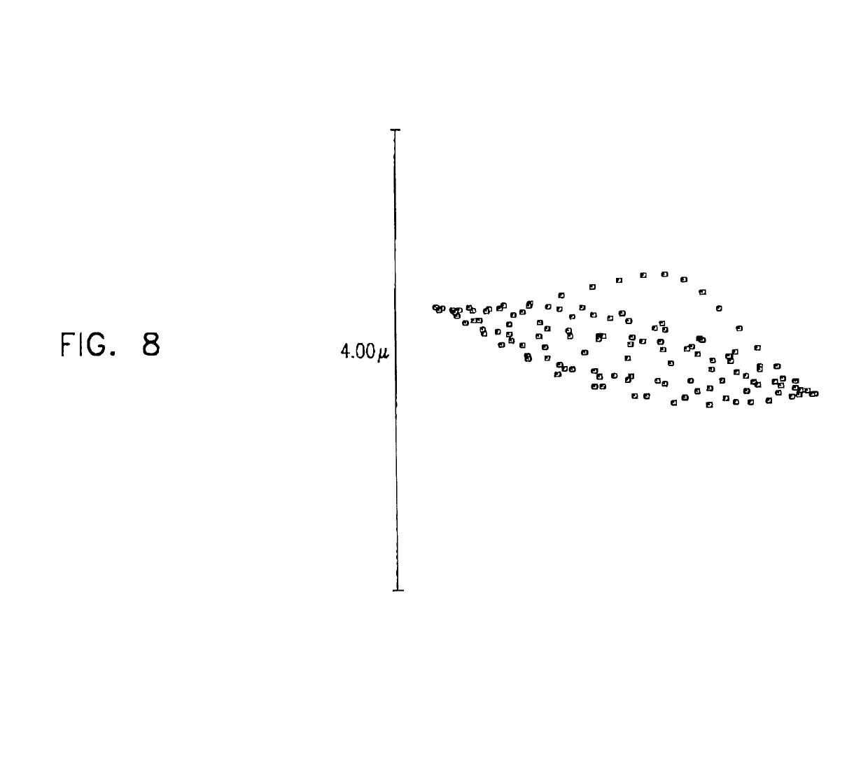

Reference is now made to FIG. 8 which is a plot of the spot diagram obtained from a point source for the optimization whose results are shown in FIG. 7 and table I. The vertical marker is 4 μm long, and is aligned along the pixel width As is observed, the point spread function is minimized along the pixel width such that good astigmatism cancellation is obtained. The maximum width is only of the order of 1 μm, and the half height width approximately 0.5 μm, in comparison with a pixel width of 7 μm.

As an example of the advantage gained by use of the present invention, the parameters and performance are given for a spectrometer for use in the visible/NIR, constructed and operative according to the present invention. The spectral range is from 570-1100 nm. The spectrometer used a 7 μm slit, a plane grating as dispersive element, and a 3000 pixel CCD array of length 21 mm, each pixel being 7 μm in width. The aberration-limited line width shown in FIG. 8 is less than 1 μm which should result in a resolution of approximately 0.03 nm for the 530 nm spectral range of the spectrometer spread out over the 21,000 μm length of the detector array. In practice, a number of factors caused the linewidth obtained in the spectrometer constructed to be about one order of magnitude larger, and the resolution obtained was thus only of the order of 0.3 nm. In the first place, the use of a finite width slit results in a corresponding increase of the linewidth. Secondly, use was made of low-cost lenses, in keeping with the claimed cost advantages of the spectrometer of the present invention. The desired optical design was not thus implemented with high precision. However, these figures are sufficient to illustrate the potential resolution possible from the aberration-compensation procedures according to this embodiment of the present invention, for instance, by the use of a narrower slit and by the use of higher precision optics.

By using inter-pixel intensity computational methods, wavelength repeatability, as expressed by the peak identification accuracy, of better than ±0.05 nm. is obtained. Finally, as a result of the reduction in size made possible by the present invention, the size of the spectrometer measurement head with the performance mentioned above is only 100 mm×90 mm×70 mm.

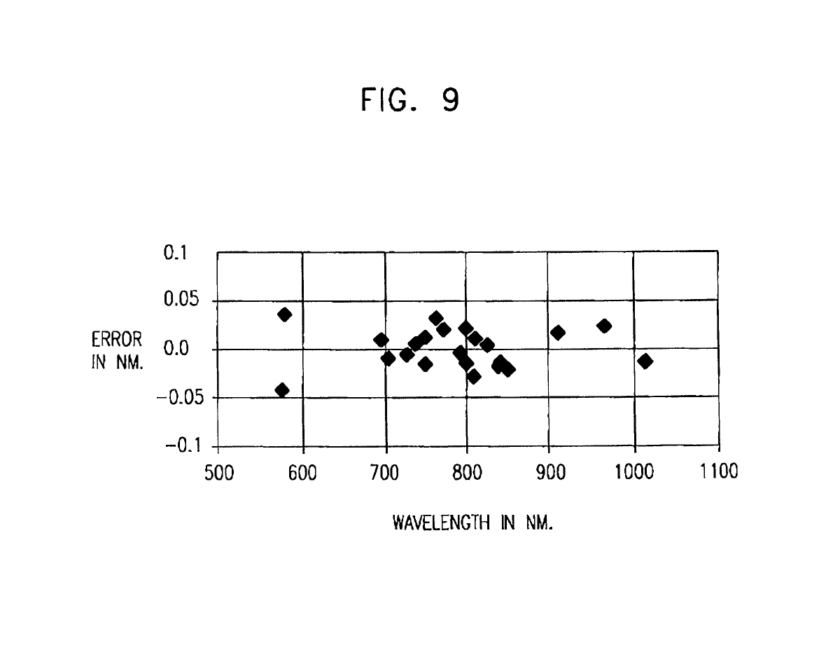

Reference is now made to FIG. 9, which is a graph of measurements of the accuracy of a spectrometer constructed according to the present invention, as shown in FIG. 6. The measurements were taken of the spectral output of a Mercury-Argon discharge lamp, and the measured error from the known positions of the measured lines plotted as a function of the line wavelengths themselves, from the 577 nm. line to the 1014 nm line. As is observed from FIG. 9, the maximum single line error measured was of the order of 0.04 nm. while the standard deviation of all of the lines measured was 0.02 nm.

It will be appreciated by persons skilled in the art that the present invention is not limited by what has been particularly shown and described hereinabove. Rather the scope of the present invention includes both combinations and subcombinations of various features described hereinabove as well as variations and modifications thereto which would occur to a person of skill in the art upon reading the above description and which are not in the prior art.

I claim:

1. A spectrometer comprising an input collimating plane and a dispersion plane aligned at a substantially different angle from each other.

2. A spectrometer according to claim 1 and wherein said input collimating plane and said dispersion plane are essentially perpendicular.

3. A spectrometer comprising an input slit, a dispersive element and a detector element, wherein said dispersive element is aligned such that a beam of light from said input slit dispersed by said element and impinging on said detector element, follows an essentially non-planar path.

4. A spectrometer according to claim 3 and wherein said dispersive element is a diffraction grating.

5. A spectrometer according to claim 4 and wherein said diffraction grating is planar.

6. A spectrometer according to claim 3, and also comprising at least one mirror for performing input collimation and output focusing.

7. A spectrometer according to claim 6 and wherein said at least one mirror is concave.

8. A spectrometer according to claim 7 and wherein said at least one mirror is spherical.

9. A spectrometer according to claim 6, and wherein said at least one mirror is a single mirror.

10. A spectrometer according to claim 1, and also comprising a correction lens assembly operative to reduce optical aberrations.

11. A spectrometer according to claim 3, and also comprising a correction lens assembly operative to reduce optical aberrations.

12. A spectrometer according to claim 10, and wherein said correction lens assembly is also operative to reduce the optical path length of said spectrometer.

13. A spectrometer according to claim 11, and wherein said correction lens assembly is also operative to reduce the optical path length of said spectrometer.

14. A spectrometer according to claim 10, and wherein said correction lens assembly is disposed such that the beam passes through said lens assembly on each of its traverses through said spectrometer.

15. A spectrometer according to claim 11, and wherein said correction lens assembly is disposed such that the beam passes through said lens assembly on each of its traverses through said spectrometer.

16. A spectrometer according to claim 15, and wherein said traverses comprise passage from said input slit to said mirror, from said mirror to said dispersive element, from said dispersive element to said mirror and from said mirror to said detector element.

17. A spectrometer according to claim 16, and wherein each of said beam traverses takes place approximately paraxially.

18. A spectrometer according to claim 16, and wherein said lens assembly is optimized to reduce aberrations by performing ray tracing with the rays passing through the lens assembly on each traverse through said spectrometer.

19. A method of reducing the size of a spectrometer having a dispersive element and an input collimating plane, by aligning said dispersive element such that light is dispersed in a plane at an angle significantly different to said input collimation plane.

20. The method of claim 19 and also comprising the step of using a single element for reflecting the beam to and from said dispersive element.

21. A method of reducing aberrations in a spectrometer having a dispersive element, an input collimating plane, at least one beam reflector and at least one correcting lens, comprising the steps of:
aligning said dispersive element such that light is dispersed in a plane at an angle significantly different to said input collimation plane;
reflecting said dispersed light off said at least one beam reflector such that the beams before and after reflection are closely disposed;
inserting said at least one correcting lens in the path of said beams; and
optimizing at least one of said at least one correcting lens and its position, in order to minimize said aberrations.
